(19) United States
(12) Patent Application Publication
(10) Pub. No.: US 2008/0279422 A1
(43) Pub. Date: Nov. 13, 2008

(54) IMAGE PROCESSING APPARATUS

(75) Inventor: Toru MATSUZAWA, Kutinachi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/117,225

(22) Filed: May 8, 2008

(30) Foreign Application Priority Data
May 9, 2007 (JP) 2007-124502

(51) Int. Cl. G06K 9/00

(52) U.S. Cl. 382/106

(57) ABSTRACT

An image processing apparatus includes a distance measurement section which measures a distance, on the basis of a plurality of images photographed by an imaging device at different visual point positions, from the imaging device to a subject for each pixel. A threshold setting section sets information indicative of a distance between an obstacle present between the imaging device and a main subject, and the imaging device. An image formation section compares the distance measured by the distance measurement section with the threshold information thereby to form an image from which an image of the obstacle is removed.

### CROSS-REFERENCE TO RELATED APPLICATIONS

This application is based upon and claims the benefit of priority from prior Japanese Patent Application No. 2007-124502, filed May 9, 2007, the entire contents of which are incorporated herein by reference.

### BACKGROUND OF THE INVENTION

1. Field of the Invention

The present invention relates to an image processing apparatus and, particularly, to an image processing apparatus capable of producing an image removed an obstacle positioned in front of a subject.

2. Description of the Related Art

When photography is performed of various scenes, if an obstacle is present between an imaging device and a main subject, the main subject is hidden behind the obstacle, and a desired image cannot be obtained in some cases.

Conversely, when the obstacle is a person, a vehicle or the like, a method is proposed in, for example, Jpn. Pat. Appln. KOKAI Publication No. 2001-43458, in which a background image is extracted from the motion parallax, thereby removing the obstacle. In the method disclosed in Jpn. Pat. Appln. KOKAI Publication No. 2001-43458, a plurality of images taken at different times are compared with one another for each pixel, and pixels in which no change is detected for a predetermined period of time are extracted as the background image. Such processing is performed for all the pixels in the area under surveillance, whereby an image having a mere background from which the obstacle is removed is formed.

### BRIEF SUMMARY OF THE INVENTION

According to an aspect of the invention, there is provided an image processing apparatus comprising: a distance measurement section which measures a distance, on the basis of a plurality of images photographed by an imaging device at different visual point positions, from the imaging device to a subject for each pixel; a threshold setting section which sets information indicative of a distance between an obstacle present between the imaging device and a main subject, and the imaging device; and an image formation section which compares the distance measured by the distance measurement section with the threshold information thereby to form an image from which an image of the obstacle is removed.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing the configuration of an imaging device provided with an image processing apparatus according to a first embodiment of the present invention;

FIG. 2 is a view showing the configuration of a processing device provided with the image processing apparatus according to the first embodiment;

FIG. 3 is a flowchart showing processing of a distance measurement section;

FIG. 4 is a flowchart showing processing of a subject detection section;

FIG. 5 is a flowchart showing processing of an image formation section;

FIGS. 6A and 6B are views each showing an example of an image photographed at different visual point positions;

FIGS. 7A and 7B are views each showing an image separated by binary information; and

FIG. 8 is a view showing an example of an image obtained in the image formation section.

### DETAILED DESCRIPTION OF THE INVENTION

Embodiments of the present invention will be described below with reference to the accompanying drawings.

### First Embodiment

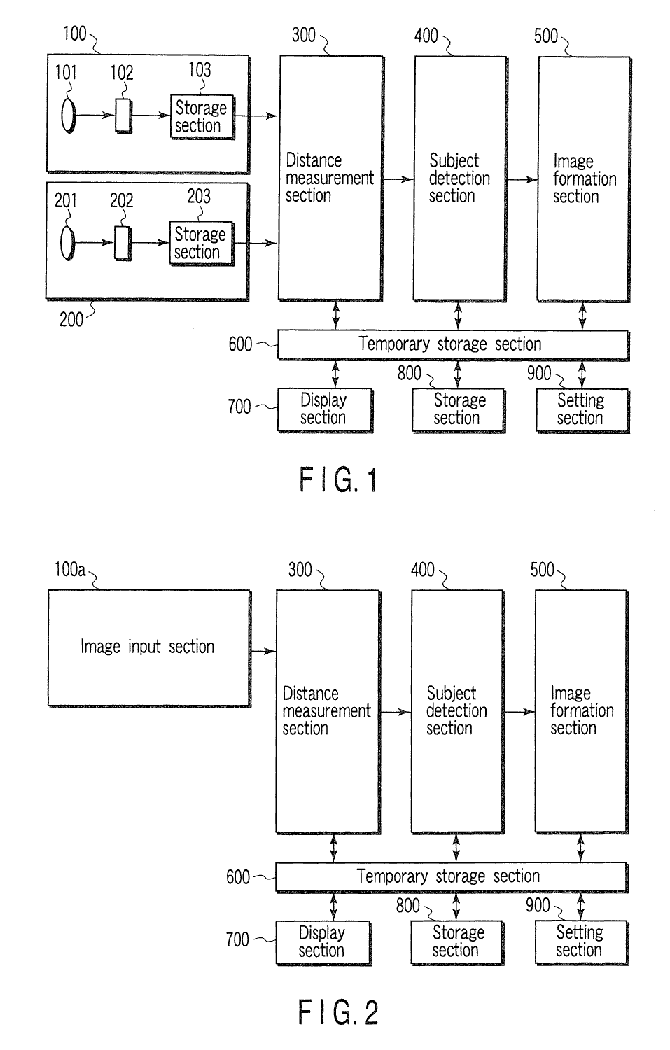

FIG. 1 is a view showing the configuration of an imaging device provided with an image processing apparatus according to a first embodiment of the present invention. The imaging device of FIG. 1 comprises imaging sections 100 and 200, a distance measurement section 300, a subject detection section 400, an image formation section 500, a temporary storage section 600, a display section 700, a storage section 800, and a setting section 900.

The imaging sections 100 and 200 constitute a stereo camera contrived for the purpose of acquiring image signals of a plurality of frames for each visual point position by imaging a subject at different visual point positions. The imaging section 100 includes an optical system 101, an image sensor 102, and a storage section 103. The imaging section 200 includes an optical system 201, an image sensor 202, and a storage section 203. Each of the optical systems 101 and 201 condenses light flux from the subject and forms an image on the corresponding image sensor. Each of the image sensors 102 and 202 converts the image of the subject formed and obtained by each of the optical systems 101 and 201 into an analog electrical signal. Furthermore, each of the image sensors 102 and 202, after converting the analog electrical signal into a digital signal (image signal), stores the converted digital signal in the corresponding storage section. Each of the storage sections 103 and 203 temporarily stores therein the image signal obtained by each of the image sensors 102 and 202.

The distance measurement section 300 acquires distance information on a distance from itself to the subject in units of pixels by using image signals of N frames (N≧2) obtained by the imaging sections 100 and 200. The subject mentioned herein is that including both the main subject and the background subject (subject other than the main subject). Hereinafter, a set of distance information obtained by the distance measurement section 300 in units of pixels will be referred to as an image range.

The subject detection section 400 provided with a function of a threshold setting section sets threshold information for detecting a region in which a subject of interest is present on the basis of focal distance information of the optical system. Further, the subject detection section 400 detects the region in which the subject of interest is present by using the set threshold information and the range image obtained by the distance measurement section 300. It is assumed here that the subject of interest mentioned herein is a subject upon which emphasis is laid in the removal processing of an obstacle, which will be described later in detail. The image formation section 500 performs predetermined image processing on the basis of the region information indicating presence/absence of the subject of interest extracted by the subject detection section 400.

Detailed operations of the distance measurement section 300, subject detection section 400, and image formation section 500 will be described later.

The temporary storage section 600 temporarily stores therein data processed by the distance measurement section 300, subject detection section 400, and image formation section 500. The display section 700 displays various images. The storage section 800 stores therein images processed by the image formation section 500. The setting section 900 is an operation section by which a photographer performs various items of setting.

Here, although the imaging device shown in FIG. 1 has a twin-lens stereo camera configuration provided with two imaging sections, the number of imaging sections is not limited to two. For example, a configuration provided with three or more imaging sections or a configuration in which imaging is performed a plurality of times while changing the visual point position by one or more imaging sections may be used.

Further, although FIG. 1 shows the configuration of the imaging device, this embodiment can also be applied to a processing device in which an image processing program is installed as shown in FIG. 2. In the processing device shown in FIG. 2, although the basic configuration is the same as that shown in FIG. 1, the configuration of the processing device differs from the configuration shown in FIG. 1 in being provided with an image input section 10a in place of the imaging sections 100 and 200. The image input section 100a shown in FIG. 2 is an image input section contrived for the purpose of acquiring image signals of a plurality of frames obtained by imaging a subject at different visual point positions. The image input section 10a is constituted of an arbitrary storage medium in which image signals of a plurality of frames are already stored. Incidentally, a configuration in which a storage medium also has an output function may be used as the image input section 100a or a part of the function of the storage section 800 may include the function of the image input section 100a.

Subsequently, a series of operations from distance measurement to image formation in the configuration shown in FIG. 1 or 2 will be described below. In the subsequent and later descriptions, the imaging sections 100 and 200, and the image input section 100a are collectively called an image input section.

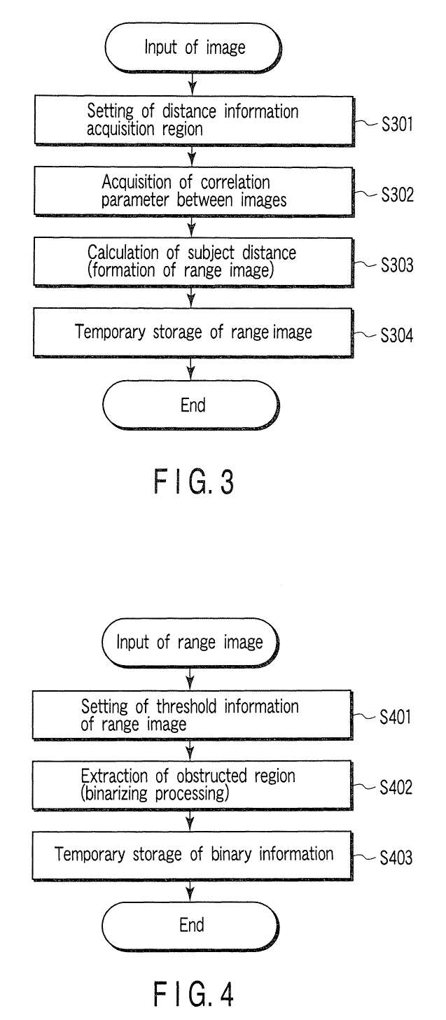

FIG. 3 is a flowchart showing a flow of fundamental operations in the distance measurement section 300.

When images of N frames is input from the image input section to the distance measurement section 300, the distance measurement section 300 sets a region for acquiring distance information from the images of N frames (step S301). This distance information acquisition region may be set by, for example, a photographer by operating the setting section 900 or may be automatically set by the distance measurement section 300.

After the distance information acquisition region is set, the distance measurement section 300 calculates corresponding points between images of N frames in the distance information acquisition region by using, for example, an image correlation method for calculating correlation amount between images, and stores a correlation parameter of the corresponding point in the temporary storage section 600 (step S302). Thereafter, the distance measurement section 300 calculates information on a distance from the device to the subject for each pixel on the basis of the correlation parameter of the corresponding point (step S303). Further, the distance measurement section 300 stores the thus obtained range image in the temporary storage section 600 (step S304).

FIG. 4 is a flowchart showing a flow of fundamental operations in the subject detection section 400.

First, the subject detection section 400 calculates threshold information of the range image on the basis of parameters such as focal distance information and the like at the time of photography, and sets the calculated threshold information (step S401). Here, the focal distance information is the focal distance information of the optical system (optical systems 101 and 201, which are hereinafter referred to simply as an optical system) at the time of photography. However, when digital zooming is performed before photography, the focal distance information of the optical system at the time of photography is changed in accordance with the zoom factor at the time of digital zooming.

In response to the setting of the threshold information, the subject detection section 400 reads the range image stored in the temporary storage section 600. Then, the subject detection section 400 binarizes the distance information of each pixel of the range image in accordance with the threshold information (step S402). After binarizing the distance information of each pixel in accordance with the threshold information, the subject detection section 400 stores the binary information of each pixel in the temporary storage section 600 (step S403).

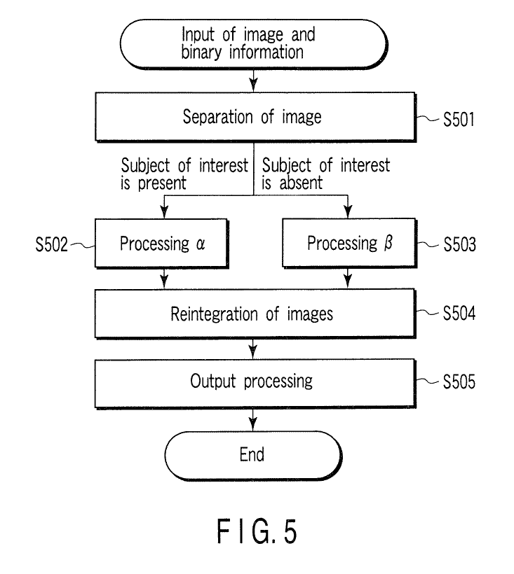

FIG. 5 is a flowchart showing a flow of fundamental operations in the image formation section 500.

First, the image formation section 500 reads the binary information obtained by the subject detection section 400 and the image obtained by the image input section which are stored in the temporary storage section 600. Further, the image formation section 500 separates the read image into two regions on the basis of the binary information (step S501). Thereafter, the image formation section 500 subjects, of the two separated regions, one region in which the subject of interest is present to processing α (step S502). Further, the image formation section 500 subjects the other region in which the subject of interest is absent to processing β, which is different from the processing α (step S503).

After completing image processing corresponding to each region, the image formation section 500 integrates individually processed images into one image (step S504). Thereafter, the image formation section 500 performs output processing such as displaying the integrated image on the display section 700 and storing the image in the storage section 800 (step S505).

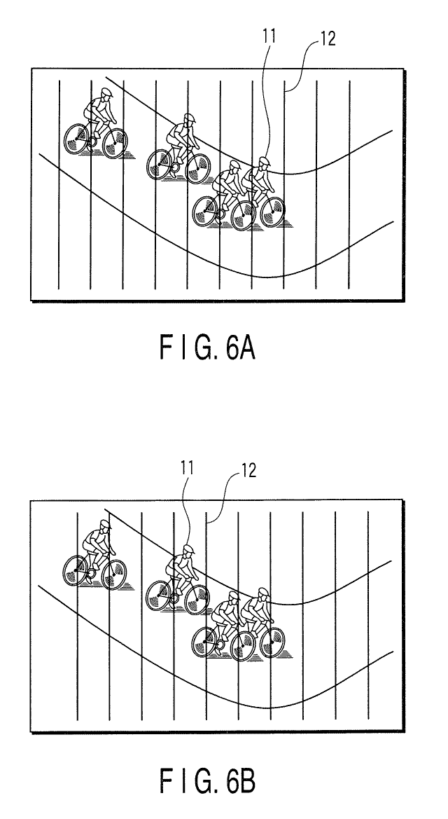

Subsequently, operations of the imaging device of the first embodiment will be further described below. Here, in the example to be described below, images acquired in the image input section are images of two frames shown in FIGS. 6A and 6B. It is assumed that the image in FIG. 6A is an image (standard image) on the standard side when the image correlation method is used to calculate a range image. Further, it is assumed that the image in FIG. 6B is an image (reference image) on the reference side when the image correlation method is used to calculate the range image.

Further, in this example, both FIGS. 6A and 6B are based on the assumption that the persons 11 are the main subject, and the fence 12 present in front of the persons 11 is the obstacle of the main subject. Further, the standard image (FIG. 6A) and the reference image (FIG. 6B) are used to calculate a range image. Subject detection in which the obstacle is regarded as the subject of interest is performed on the basis of the calculated range image. Further, the standard image is separated into a region in which the obstacle which is the subject of interest is present and a region in which the subject of interest is not present and, thereafter the respective regions are subjected to different types of image processing (processing α, processing β).

First, the distance measurement section 300 acquires distance information. Prior to this processing, the photographer selects the standard image and the reference image by using the setting section 900, and further sets the distance information acquisition region in the standard image. For example, the distance information acquisition region is set as the entire region of the standard image shown in FIG. 6A. In response to this setting operation, the distance measurement section 300 obtains a correlation between the standard image and the reference image in the distance information acquisition region. Further, the distance measurement section 300 calculates a subject distance for each pixel in the distance information acquisition region of the standard image from the obtained correlation amount. The distance measurement section 300 stores the calculated result in the temporary storage section 600 as the range image. In this manner, information on the correspondence between the pixel position (X and Y coordinates) and the subject distance in the distance information acquisition region of the standard image is stored in the temporary storage section 600.

Subsequently, the subject detection section 400 detects the subject of interest. Prior to this processing, the photographer sets a margin of the threshold such that a distance equal to or slightly larger than the distance from the device to the fence 12 is regarded as the threshold information by using the setting section 900. After this, AF control is performed by the imaging section and, the focus of the optical system is adjusted so that, for example, a point in the vicinity of the nearest subject (fence 12 in this case) can be in focus. Thereafter, the subject detection section 400 calculates a distance from the device to the subject (fence 12 in this case) in focus from the threshold margin and the focal distance of the optical system of the imaging section at the time of photography, and sets this distance as the threshold information. This threshold information is given as a value obtained by multiplying an inverse of the focal distance by a predetermined coefficient corresponding to the characteristic of the optical system.

In response to these setting operations, the subject detection section 400 determines whether or not the subject distance of each pixel in the distance threshold information acquisition region is within a predetermined distance range by comparing the distance information of each pixel with the threshold information on the basis of the range image and the threshold information. Further, the subject detection section 400 binarizes the determination result, and stores binary information indicating presence/absence of the subject of interest (obstacle in this case) in the temporary storage section 600. Here, the threshold information is set at a distance equal to or slightly larger than the distance from the device to the obstacle (fence 12), and hence when the subject distance is equal to or smaller than the threshold, the fence 12, which is the subject of interest, is present in front of the persons 11 who are the main subject.

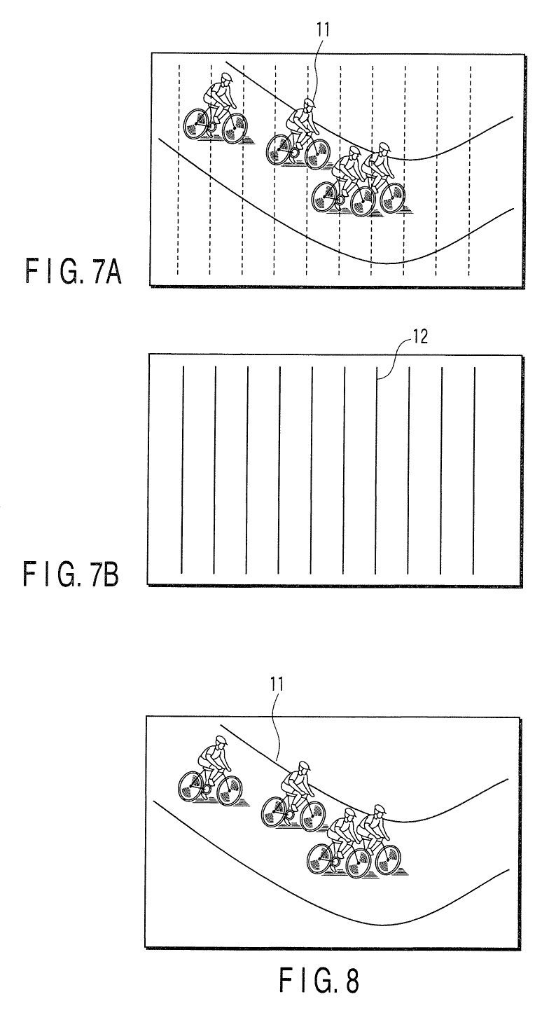

Subsequently, the image formation section 500 performs image formation processing. In this processing, the image formation section 500 first separates the standard image into two regions on the basis of the binary information obtained by the subject detection section 400. As described above, the binary information is information indicating whether or not a fence 12, which is an obstacle, is present in front of the persons 11 who are the main subject. Accordingly, when the standard image is separated into two regions on the basis of this binary information, the standard image becomes, after the separation, an image in which the fence 12, and the subject present in front of the fence 12 are included, as shown in FIG. 7A, and an image in which the subject present behind the fence 12 is included, as shown in FIG. 7B. After the separation of the standard image, the image formation section 500 subjects the obstructed region in which the subject of interest (fence 12) is present, as shown in FIG. 7A, to the processing α. In this example, as the processing α, the fence 12 in the obstructed region is regarded as defective pixels, and image signals of the defective pixels are obtained from the surrounding image signals in the same frame by interpolation. By contrast, as the processing β, no processing associated with removal of the obstacle is performed. After the image processing is completed, the image formation section 500 integrates the image of FIG. 7A and the image of FIG. 7B into one image on the basis of the binary information. That is, for pixels each having a subject distance equal to or smaller than the threshold information, the image signal of FIG. 7A is used, and, for pixels each having a subject distance equal to or larger than the threshold information, the image signal of FIG. 7B is used. The image formation section 500 outputs the image obtained by such integration in the manner shown in FIG. 8 to the outside by, for example, displaying the image on the display section 700 and storing the image data in the storage section 800.

As described above, according to the first embodiment, by a series of operations from the distance measurement in the distance measurement section 300 to the image formation in the image formation section 500, it is possible to produce the image as shown in FIG. 8 by removing the stationary obstacle (fence 12) which has been obstructing the photography of the persons 11, and forming the image of the removed part by interpolation from other image signals. Further, by previously finishing predetermined setting, such as setting of threshold information, and simplifying the operation required at the time of photography, photography to be performed by the conventional operation is enabled. As a result of this, it is possible to, even in a situation in which an obstacle is present, photograph a main subject in a sports scene, and provide an image from which the obstacle is removed.

### Second Embodiment

Next, a second embodiment of the present invention will be described below. In the second embodiment, although a configuration identical with the configuration of the first embodiment can be used as the configuration of the device, processing in each block in the second embodiment is different from that in the first embodiment. In the second embodiment, operations of a distance measurement section 300, subject detection section 400, and image formation section 500 are particularly described.

Operations of the second embodiment will be described below. First, a distance measurement section 300 acquires distance information. Prior to this processing, the photographer selects a standard image and a reference image by using a setting section 900, and further sets a zoom factor for enlarging or reducing these images by digital zooming. In response to this operation, the distance measurement section 300 sets a distance information acquisition region of the standard image. For example, the distance information acquisition region is set by extracting, from the standard image, a region which is enlarged or reduced longitudinally and laterally in accordance with an enlargement ratio set by a setting section 900 and set by using the optical central reference (a position in an image corresponding to the optical axis position of the optical system) as a center. The distance measurement section 300 obtains a correlation between the standard image and the reference image in the distance information acquisition region, and calculates a subject distance for each pixel in the distance information acquisition region of the standard image from the obtained correlation amount. Thereafter, the distance measurement section 300 stores the subject distance for each pixel in a temporary storage section 600 as the range image. In this manner, information on the correspondence between the pixel position (X and Y coordinates) and the subject distance in the distance information acquisition region of the standard image is stored in the temporary storage section 600.

Subsequently, the subject detection section 400 performs detection of the subject of interest. Prior to this processing, the photographer sets a margin of the threshold such that a distance equal to or slightly larger than the distance from the device to the fence 12 is regarded as the threshold information by using the setting section 900. In response to this operation, the subject detection section 400 calculates the distance from the device to the fence 12 from the margin of the threshold, the focal distance of the optical system, and the zoom factor, and sets threshold information of the distance. The second embodiment is premised on enlargement or reduction by digital zooming, and hence, as the focal distance information used to calculate the distance from the device to the fence 12, a value obtained by multiplying the focal distance information of the optical system by the zoom factor is used. Further, the focal distance information (after being multiplied by the zoom factor) and the margin of the threshold which are set last time are stored, and when a digital zooming operation is not performed, the focal distance information and the margin of the threshold which are set last time may be used to calculate threshold information. The subject detection section 400 determines whether or not the subject distance of each pixel in the distance threshold information acquisition region is within a predetermined distance range by comparing the distance information of each pixel with the threshold information on the basis of the range image and the threshold information. Further, the subject detection section 400 binarizes the determination result, and stores binary information indicating presence/absence of the subject of interest (obstacle in this case) in the temporary storage section 600. Here, the threshold information is set at a distance equal to or slightly larger than the distance from the device to the obstacle (fence 12), and hence when the subject distance is equal to or smaller than the threshold, the fence 12, which is the subject of interest, is present in front of the persons 11 who are the main subject.

Subsequently, the image formation section 500 performs image formation processing. In this processing, the image formation section 500 first separates the standard image into two regions on the basis of the binary information obtained by the subject detection section 400. As described above, the binary information is information indicating whether or not a fence 12, which is an obstacle, is present in front of the persons 11 who are the main subject. Accordingly, when the standard image is separated into two regions on the basis of this binary information, the standard image becomes, after the separation, an image in which the fence 12 and the subject present in front of the fence 12 are included, and an image in which the subject present behind the fence 12 is included. After the separation of the standard image, the image formation section 500 subjects the obstructed region in which the subject of interest (fence 12) is present to the processing α. In this example, as the processing α, the fence 12 in the obstructed region is regarded as defective pixels, and image signals of the defective pixels are obtained from the surrounding image signals in the same frame by interpolation. By contrast, as the processing β, no processing associated with removal of the obstacle is performed. After the image processing is completed, the image formation section 500 integrates the image in which the subject distance is equal to or smaller than the threshold information, and the image in which the subject distance exceeds the threshold information into one image on the basis of the binary information. After the integration, the image formation section 500 outputs the image obtained in the manner shown in FIG. 8 to the outside by, for example, displaying the image on the display section 700 and storing the image data in the storage section 800.

As described above, according to the second embodiment, by a series of operations from the distance measurement in the distance measurement section 300 to the image formation in the image formation section 500, it is possible to produce the image as shown in FIG. 8 by removing the fence 12 which has been obstructing the photography of the persons 11, and forming the image of the removed part by interpolation from other image signals. This enables the second embodiment to obtain the same effect as the first embodiment. Furthermore, in the second embodiment, even when digital zooming is performed before the image from which the fence 12 that is the obstacle is removed is produced, the threshold information is automatically set. Further, the image is enlarged or reduced by digital zooming, whereby it is possible to continuously perform photography in a short time without driving of a zoom lens, as in optical zooming. Further, if this method is used when the angle of view at the output time is equal to that at the time of optical zooming, photography can be performed at a wider angle, and hence it is possible to perform photography in a scene in which the obstacle is too near to be in focus, and easily perform following of a main subject by a wide-angle shot.

### Third Embodiment

Next, a third embodiment of the present invention will be described below. In the third embodiment, a configuration identical with the configuration of the first embodiment can be used as the configuration of the device. In the third embodiment, the processing from distance measurement in a distance measurement section 300 to subject detection in a subject detection section 400 is identical with the first embodiment, and hence a description thereof is omitted.

Operations of the third embodiment will be described below. In an image formation section 500, image formation processing is performed. In this processing, the image formation section 500 separates the standard image into two regions on the basis of the binary information obtained by the subject detection section 400. As described previously, the binary information is information indicating whether or not a fence 12 which is an obstacle is present in front of persons 11 who are the main subject. Accordingly, when the separation is performed on the basis of the binary information, the standard image becomes, after the separation, an image in which the fence 12, and the subject present in front of the fence 12 are included, shown in FIG. 7A, and an image in which the subject present behind the fence 12 is included, shown in FIG. 7B. After the separation of the standard image, the image formation section 500 subjects the obstructed region in which the subject of interest (fence 12) is present, shown in FIG. 7A, to the processing α. In this example, as the processing α, the fence 12 in the obstructed region is regarded as defective pixels, and image signals of the defective pixels are obtained from the surrounding image signals in the same frame by interpolation. By contrast, as the processing β, no processing associated with removal of the obstacle is performed. After the image processing is completed, the image formation section 500 integrates the image of FIG. 7A and the image of FIG. 7B into one image on the basis of the binary information. That is, for pixels each having a subject distance equal to or smaller than the threshold information, the image signal of FIG. 7A is used, and, for pixels each having a subject distance equal to or larger than the threshold information, the image signal of FIG. 7B is used. The image formation section 500 outputs the image obtained by such integration in the manner shown in FIG. 8 to the outside by, for example, displaying the image on the display section 700 and storing the image data in the storage section 800. Further, when enlargement or reduction of the image is required, an image of the desired size is obtained by enlarging or reducing the image obtained after the reintegration by digital zooming performed by the image formation section 500.

As described above, according to the third embodiment, by a series of operations from the distance measurement in the distance measurement section 300 to the image formation in the image formation section 500, it is possible to produce the image as shown in FIG. 8 by removing the fence 12 which has been obstructing the photography of the persons 11, and forming the image of the removed part by interpolation from other image signals. This enables the third embodiment to obtain the same effect as the first embodiment. Further, in the third embodiment, the image is enlarged or reduced by digital zooming, whereby it is possible to continuously perform photography in a short time without driving of a zoom lens, as in optical zooming. Further, if this method is used when the angle of view at the output time is equal to that at the time of optical zooming, photography can be performed at a wider angle, and hence it is possible to perform photography in a scene in which the obstacle is too near to be in focus, and easily perform following of a main subject by a wide-angle shot. Furthermore, in the third embodiment, digital zooming is performed after the reintegration of the images, whereby the processing operations to be performed up to the reintegration of the images can be performed by using a few image signals extracted in the distance information acquisition region of the standard image. As a result, the storage region needed for storing images can be further reduced, and speedup of the image formation processing can be realized as compared with the second embodiment.

### Fourth Embodiment

Next, a fourth embodiment of the present invention will be described below. In the fourth embodiment, a configuration identical with the configuration of the first embodiment can be used as the configuration of the device. However, an optical system provided in an imaging section of the fourth embodiment includes a zoom lens. In the fourth embodiment, operations of a distance measurement section 300 and a subject detection section 400 will be particularly described.

Operations of the fourth embodiment will be described below. First, a distance measurement section 300 acquires distance information. Prior to this processing, the photographer selects the standard image and the reference image by using a setting section 900. Further, the photographer performs an operation of optical zooming for setting the position of the zoom lens. In response to this operation, the distance measurement section 300 sets a distance information acquisition region in the standard image. For example, the distance information acquisition region is set as the entire region of the standard image shown in FIG. 6A. In response to this setting operation, the distance measurement section 300 obtains a correlation between the standard image and the reference image in the distance information acquisition region, and calculates a subject distance for each pixel in the distance information acquisition region of the standard image from the obtained correlation amount. After this, the distance measurement section 300 stores the subject distance for each pixel in a temporary storage section 600 as the range image. In this manner, information on the correspondence between the pixel position (X and Y coordinates) and the subject distance in the distance information acquisition region of the standard image is stored in the temporary storage section 600.

Subsequently, the subject detection section 400 performs detection of the subject of interest. Prior to this processing, the photographer sets a margin of the threshold such that a distance equal to or slightly larger than the distance from the device to the fence 12 is regarded as the threshold information by using the setting section 900. In response to this operation, the subject detection section 400 calculates the distance from the device to the fence 12 from the margin of the threshold, and the focal distance of the optical system of the imaging section at the time of photography, and sets threshold information of the distance. Here, the focal distance information and the margin of the threshold which are set last time are stored, and when an optical zooming operation is not performed, the focal distance information and the margin of the threshold which are set last time may be used to calculate threshold information. This makes it unnecessary to set the threshold information each time photography is performed. Thereafter, the subject detection section 400 determines whether or not the subject distance of each pixel in the distance threshold information acquisition region is within a predetermined distance range by comparing the distance information of each pixel with the threshold information on the basis of the range image and the threshold information. Further, the subject detection section 400 binarizes the determination result, and stores binary information indicating presence/absence of the subject of interest (obstacle in this case) in the temporary storage section 600. Here, the threshold information is set at a distance equal to or slightly larger than the distance from the device to the obstacle (fence 12), and hence when the subject distance is equal to or smaller than the threshold, the fence 12, which is the subject of interest, is present in front of the persons 11 who are the main subject.

As described above, according to the fourth embodiment, by a series of operations from the distance measurement in the distance measurement section 300 to the image formation in the image formation section 500, it is possible to produce the image as shown in FIG. 8 by removing the obstacle (fence 12) which has been obstructing the photography of the persons 11, and forming the image of the removed part by interpolation from other image signals. Furthermore, in the fourth embodiment, the image is enlarged or reduced by optical zooming, whereby it is possible to form an image of higher-resolution than the enlargement or reduction by digital zooming.

### Fifth Embodiment

Next, a fifth embodiment of the present invention will be described below. The fifth embodiment relates to processing to be performed after image formation in an image formation section 500 is performed.

First, before an image from which a fence 12 is removed is formed, the photographer performs switching of the output mode after the image from which the fence 12 is removed is formed by operating a setting section 900. The output modes are a mode in which, for example, one of an image from which the fence 12 which is an obstacle is removed shown in FIG. 8, and a standard image before the fence 12 is removed therefrom shown in FIG. 6A is stored in a storage section 800, and a mode in which both the images are stored.

After the output mode is set, a series of processing operations from image acquisition to image formation is performed in the same manner as in the first to fourth embodiments. Thereafter, in the fifth embodiment, one of or both the image of FIG. 8 and the image of FIG. 6A is or are stored in the storage section 800 in accordance with the output mode set by the photographer.

As described above, according to the fifth embodiment, it is made possible to select whether both the images before and after the removal of the fence 12 which is the obstacle are to be stored in the storage section 800 or only one of the images is to be stored in the storage section 800. This makes it possible for, for example, the photographer to select, after comparing the images before and after the removal of the fence 12 with each other to determine whether or not the images are in a satisfactory finished state, the image the photographer prefers.

### Sixth Embodiment

Next, a sixth embodiment of the present invention will be described below. The sixth embodiment also relates to processing to be performed after image formation in an image formation section 500 is performed.

First, before an image from which a fence 12 is removed is formed, the photographer performs switching of the output mode after the image from which the fence 12 is removed is formed by operating a setting section 900. The output modes are a mode in which, for example, one of an image from which the fence 12 which is an obstacle is removed shown in FIG. 8, and a standard image before the fence 12 is removed therefrom shown in FIG. 6A is displayed on a display section 700, and a mode in which both the images are displayed.

After the output mode is set, a series of processing operations from image acquisition to image formation is performed in the same manner as in the first to fourth embodiments. Thereafter, in the sixth embodiment, one of or both the image of FIG. 8 and the image of FIG. 6A is or are displayed on a display section 700 in accordance with the output mode set by the photographer. The photographer confirms the images displayed on the display section 700, and selects one of the images by means of the setting section 900. In response to this, the selected image is stored in a storage section 800.

As described above, according to the sixth embodiment, it is made possible to select whether both the images before and after the removal of the fence 12, which is the obstacle, are to be displayed on the display section 700 or only one of the images is to be displayed on the display section 700. This makes it possible for, for example, the photographer to select, after comparing the images before and after the removal of the fence 12 with each other to determine whether or not the images are in a satisfactory finished state, the image the photographer prefers. Further, before the selection of the image is performed by using the setting section 900, the image is not stored, and hence it is not necessary to store both the images before and after the removal of the fence 12, thereby making it possible to save the capacity of the storage section 800.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a distance measurement section which measures a distance, on the basis of a plurality of images photographed by an imaging device at different visual point positions, from the imaging device to a subject for each pixel;
a threshold setting section which sets information indicative of a distance between an obstacle present between the imaging device and a main subject, and the imaging device; and
an image formation section which compares the distance measured by the distance measurement section with the threshold information thereby to form an image from which an image of the obstacle is removed.

2. The image processing apparatus according to claim 1, further comprising an image enlargement section which electrically enlarges at least one of the plurality of images, prior to formation of the image in the image formation section.

3. The image processing apparatus according to claim 1, further comprising an image enlargement section which electrically enlarges the image formed in the image formation section.

4. The image processing apparatus according to claim 1, further comprising an enlargement/reduction section which optically changes a magnification with respect to the plurality of images photographed by the imaging device prior to the formation of the image in the image formation section.

5. The image processing apparatus according to claim 1, further comprising a storage section which stores both an image after removal of an image of the obstacle, and an image before the removal of the image of the obstacle.

6. The image processing apparatus according to claim 2, further comprising a storage section which stores both an image after removal of an image of the obstacle, and an image before the removal of the image of the obstacle.

7. The image processing apparatus according to claim 3, further comprising a storage section which stores both an image after removal of an image of the obstacle, and an image before the removal of the image of the obstacle.

8. The image processing apparatus according to claim 4, further comprising a storage section which stores both an image after removal of an image of the obstacle, and an image before the removal of the image of the obstacle.

9. The image processing apparatus according to claim 1, further comprising:
a display section which displays at least one of an image after removal of an image of the obstacle, and an image before the removal of the image of the obstacle;
a selection section which selects an image for storing from the displayed image; and
a storage section which stores the selected image.

10. The image processing apparatus according to claim 2, further comprising:
a display section which displays at least one of an image after removal of an image of the obstacle, and an image before the removal of the image of the obstacle;
a selection section which selects an image for storing from the displayed image; and
a storage section which stores the selected image.

11. The image processing apparatus according to claim 3, further comprising:
a display section which displays at least one of an image after removal of an image of the obstacle, and an image before the removal of the image of the obstacle;
a selection section which selects an image for storing from the displayed image; and
a storage section which stores the selected image.

12. The image processing apparatus according to claim 4, further comprising:
a display section which displays at least one of an image after removal of an image of the obstacle, and an image before the removal of the image of the obstacle;
a selection section which selects an image for storing from the displayed image; and
a storage section which stores the selected image.
